(19) United States
(12) Patent Application Publication
(10) Pub. No.: US 2008/0041828 A1
(43) Pub. Date: Feb. 21, 2008

(54) Single-head multiple-electrode resistance welder

(75) Inventors: Egon Lang, Rothis (AT); Michael Dablander, Wangle (AT)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 11/810,137

(22) Filed: Jun. 4, 2007

(30) Foreign Application Priority Data
Jun. 3, 2006 (DE) 102006026111.9

(51) Int. Cl. B23K 11/31

(52) U.S. Cl. 219/119

(57) ABSTRACT

A resistance-welder welding head has a support, an electrode holder, a quick-release fastener releasably securing the holder on the support, and two electrodes with different properties fixed to the electrode holder.

### FIELD OF THE INVENTION

The present invention relates to resistance welding. More particularly this invention concerns an apparatus for resistance welding, that is a resistance welder, and a method of using the apparatus.

### BRIEF DESCRIPTION OF THE DRAWING

The above and other objects, features, and advantages will become more readily apparent from the following description, reference being made to the accompanying drawing in which:

FIG. 1A is a top view of a workpiece of the type normally produced by resistance welding;

FIGS. 1B and 1C are end views illustrating a standard resistance-welding process;

FIGS. 2A, 2B, 2C, and 2D are small-scale vies illustrating different resistance-welding systems;

FIG. 3 is a side view of a resistance welder according to the invention; and

FIGS. 4 and 5 are end views illustrating use of the resistance welder of FIG. 3.

### BACKGROUND OF THE INVENTION

Resistance welding is frequently used to join components of mechatronic products. It is based on Joule-resistance heating as current flows through the workpieces to be joined. In resistance welding, no fusible electrode and no electric arc are required. The metal is joined by heating the contact surfaces of the workpieces by passing a substantial electric current through the joint area such that its ohmic resistance creates heat that fuses the normally metallic parts in the joint area. The parts being joined are simultaneously or subsequently pressed together and then allowed to cool, once the current is cut, so that the fused area hardens. When the fused regions are contacting surfaces, a unitary weld is formed between the parts having the fused regions. For resistance welding, high current power and low voltage are required. This type of welded connection is quite strong, can be done quickly, and produces little in the way of environmental problems.

Normally electric current is transmitted between the electrodes and force is exerted to press the workpieces together by the weld electrodes. The workpieces are welded under pressure on the abutting surfaces after sufficient heating. It is possible to weld one point or a plurality at the same time (single-spot welding, multiple-spot welding). In single-sided spot welding the current is supplied from one workpiece side by electrodes adjacent to each other. In two-sided spot welding the current is supplied by electrodes flanking both workpieces directly opposite each other.

Due to different component geometries and materials of the parts to be welded, the use of different welding electrodes is required.

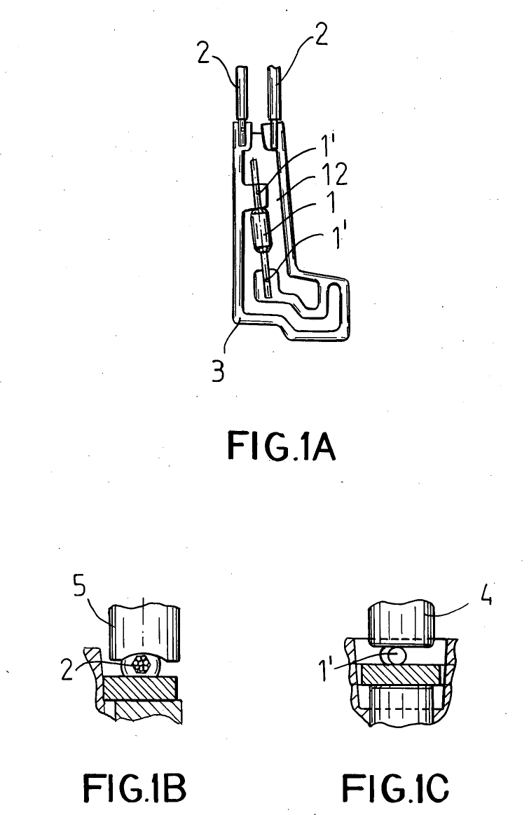

FIG. 1A shows by way of example the welding operation on a mechatronic assembly. In the example, leads 1′ of a resistor 1 and conductors 2 of wires are to be welded to traces 3 of a stamped base body or printed-circuit board 12. The resistor traces 1′ are solid and illustrated can only be successfully welded with the electrode 4 and the stranded conductors 2 only with the electrode 5.

If two or more electrodes are required for a resistance welding operation, it is common to use a separate welding head with a dedicated electrode holder for each electrode. The number of electrodes is determined by the electrode materials selected for the relevant usage conditions of the operation and the selected shape, attachment and cooling of the electrodes.

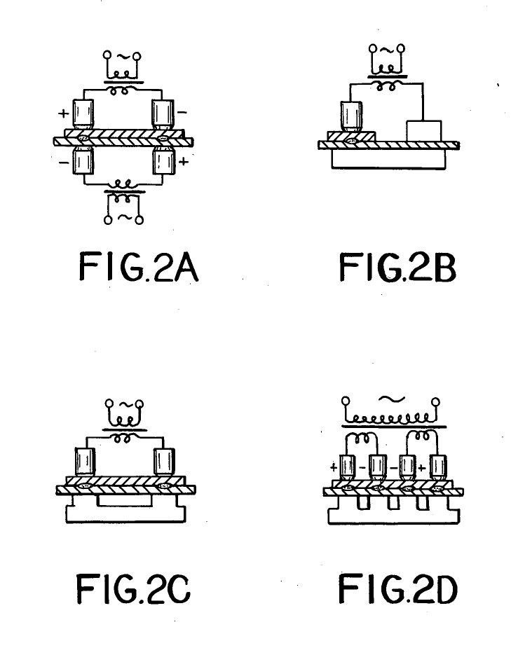

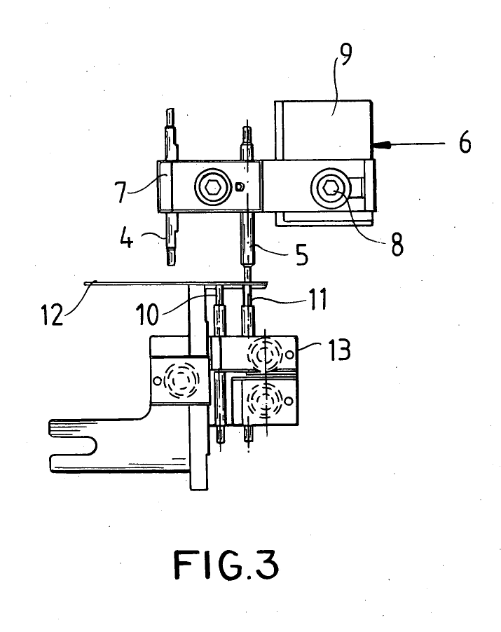

One exception to this is multiple spot welding, where a plurality of welding spots are generated successively or simultaneously during a welding cycle time using two or more electrodes. For example, two individual welding spots are produced in the case of single-sided double-spot welding in one welding cycle time. The same current flows through two electrodes (FIGS. 2B and 2C) within a single circuit (series connection). In the case of multi-spot welding, in one welding cycle two or more welding spots are generated (FIGS. 2A, 2C, 2D). Polarity and phase positions are shown in FIGS. 2A and 2D.

### OBJECTS OF THE INVENTION

It is therefore an object of the present invention to provide an improved resistance-welder head.

A further object is to provide an improved resistance-welding method.

Another object is the provision of such an improved resistance-welder head and resistance-welding method that overcome the above-given disadvantages, in particular that can also be used to cost-efficiently produce two or more welds, where different electrodes are required.

### SUMMARY OF THE INVENTION

A resistance-welder welding head has according to the invention a support, an electrode holder, a quick-release fastener releasably securing the holder on the support, and two electrodes with different properties fixed to the electrode holder.

According to the invention, it is therefore provided that at least two electrodes having different electrode properties are mounted in an electrode holder attached to the welding head in a quick-release manner. As a result, using only one welding head welding parts requiring different electrodes can be produced in a cost-efficient manner. The quick replacement of the electrode holder reduces equipment down time.

Preferably the electrode holder is attached to the welding head by means of a single screw and can thus be quickly and easily replaced.

The advantages of the electrode holder with the quick-release configuration are also that the electrode holder can be removed by loosening the screw or bolt and can be equipped with new electrodes away from the welding apparatus, which reduces the down time of the machine.

The electrodes for the negative pole and/or the electrodes for the positive pole are provided in a dedicated electrode holder with quick-release configuration.

The different electrode properties include the shape of the electrode tips, the lengths of the electrodes, the electrode materials, and the cooling of the electrodes.

With respect to the method, the object referred to above is achieved in that for each welding condition one electrode is mounted in the electrode holder and that for each welding operation the suitable electrode is displaced to the required welding spot by means of a vertical and/or horizontal displacement of the welding head and/or the electrode holder. Preferably interference of the electrode that is not in use with the welding operation is avoided through varying lengths of the electrodes in the electrode holder and/or a rotation of the welding head or the electrode holder. In other words the invention includes the step of holding the currently nonfunctioning electrode out of contact with the workpiece, so there is no need to electrically isolate the two electrodes from each other.

The invention can be used for both sides, meaning for the positive and the negative poles. A delimitation from multiple spot, double spot and multi-spot welding is that the different welding spots can be parameterized (welding parameters, electrodes etc.) in accordance with the relevant application conditions and electrode configurations.

The advantages of this system are:
Reduction of down time associated with electrode replacement,
use of different electrode shapes according to the application conditions.
Lower costs due to the elimination of one or more welding heads.
Lower costs due the lower number of workstations on machines.
Use of proven methods and components for implementation of the welding operation and process monitoring.

The main advantage compared to prior-art double-spot and multi-spot welding are that process monitoring is done according to the type of welding. The prospects of using process control devices in production can be considered the best with single spot welding and are rated hopeless with multiple projection welding operations.

The invention can be used wherever two or more welding spots are supposed to be implemented under varying usage conditions and with varying selected shapes, attachment and cooling of the electrodes.

With the single-head multiple-electrode resistance welding method according to the invention therefore an unlimited number of electrodes having varying lengths can be used in an electrode holder with quick-release configuration for two or more electrodes.

### SPECIFIC DESCRIPTION

As seen in FIG. 3, a welding apparatus has a support 9 for an electrode holder 7 on a welding head 6. The electrode holder 7 is configured such that it can e replaced quickly with another electrode holder. To make this possible, the electrode holder 7 in the example illustrated here is attached to the welding head by means of a single screw 8. Any type of connection is conceivable that allows the electrode holder 7 to be both firmly attached to or anchored on the welding head 6, or as in this case on the support 9, and is easily replaced.

The advantages of the electrode holder 7 with the quick-release configuration are also that the electrode holder 7 can be removed by loosening the screw 8 and can be equipped with new electrodes outside of the welding apparatus, which consequently return reduces the down time of the machine.

In FIG. 3 shows the electrode holder 7 has two electrodes 4 and 5 with different properties. The electrode 5 is shown in use, while the electrode 4 is raised so that no contact exists between it and the workpiece 12 or other components. For this reason, the two electrodes 4 and 5 also have different lengths, as a result of which they do not interfere with each other.

The opposite electrodes 10 and 11 having the opposite polarity from the electrodes 4 and 5 are beneath the workpiece 12 to be welded and are likewise mounted in an electrode holder 13 with a quick-release configuration.

The individual welding operations are performed by displacing the electrodes 4 and 5 in the x, y and z axes.

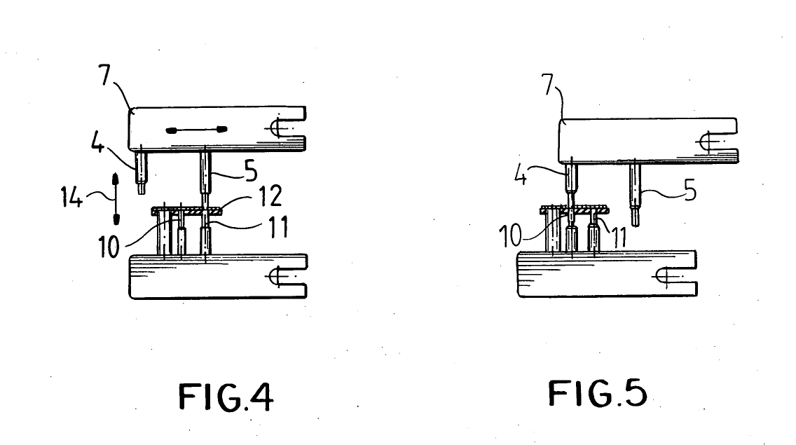

The operating principle of the single-head multiple-electrode welding head according to the invention is shown in FIGS. 4 and 5. The operation is as described below:

1. Welding the lead 1′ of the resistor 1 according to FIG. 1 to the workpiece 3 with the electrode 5.

2. Displacing the welding head 6 and/or the electrode holder 7 and thus the electrodes 4 and 5 in the vertical and horizontal directions. The welding stroke is shown at 14.

3. Welding the workpiece 3 (for example the conductor 2 according to FIG. 1) to the workpiece 2 with the electrode 4.

4. Displacing the welding head 6 and/or the electrode 7 into the starting position.

We claim:

1. A resistance-welder welding head comprising:
a support;
an electrode holder;
a quick-release fastener releasably securing the holder on the support; and
two electrodes with different properties fixed to the electrode holder.

2. The resistance-welder welding head defined in claim 1 wherein the fastener is a single screw.

3. The resistance-welder welding head defined in claim 1, further comprising
means for applying either a positive or negative voltage to the electrodes.

4. The resistance-welder welding head defined in claim 1 wherein the different properties of the electrodes are shape of electrode tip, electrode length, electrode material, and electrode cooling rate.

5. A method of using a resistance welder having a head comprising:
a support;
an electrode holder;
a quick-release fastener releasably securing the holder on the support; and
two electrodes with different properties fixed to the electrode holder,
the method comprising the steps of sequentially:
engaging one of the electrodes with a workpiece to be welded and making a resistance weld;
moving the holder to disengage the one electrode from the workpiece without moving the workpiece;
moving the holder to engage the other of the electrodes with the workpiece and making another resistance weld.

6. The resistance-welding method defined in claim 5, further comprising the step of
orienting the holder such that both of the electrodes do not contact the workpiece at any given time.
